(19) United States
(12) Patent Application Publication
(10) Pub. No.: US 2012/0296580 A1
(43) Pub. Date: Nov. 22, 2012

(54) METHOD AND SYSTEM FOR IDENTIFYING LEAKS IN LIQUID PIPE CONSTRUCTION

(76) Inventor: Dov BARKAY, Ramat Ishay (IL)

(21) Appl. No.: 13/108,288

(22) Filed: May 16, 2011

(51) Int. Cl. G06F 19/00

(52) U.S. Cl. 702/51

(57) ABSTRACT

The present invention provides a system for identifying leaks in liquids pipe construction. The system is comprised of: At least one detection unit is positioned in proximity of at least one exit point of said pipe construction comprising an acoustic sensor and a wireless communication unit, an electronically controlled shutoff unit installed on an entrance point of the pipe construction, the unit comprising a valve, an acoustic sensor and wireless communication unit arranged for transmitting data of water flow and receiving control signals, a controller network device for receiving the measurement data from all sensors. The controller is programmed to detect leaks when identifying differences between the measured liquid flow at the entrance point and measured flow at the exit points.

### BACKGROUND

1. Technical Field

The present invention relates to the field of identification of liquids in pipes construction and more specifically to identification of leak by acoustical sensors.

2. Prior Art

There are known in the art various systems for leak detection: U.S. application No. US2006174707 disclose device for detecting and control abnormal flow occurrences in a liquid or gas-carrying infrastructure using acoustics sensors.

U.S. Pat. No. 5,040,409 disclose an acoustic sensor to determine when a leak occurs in a sprinkling system. When a catastrophic leak is detected, an alarm signal is generated and a shutoff valve may be actuated in order to prevent loss of fluid and possible damage that can occur due to localized high flow of the fluid that is being sprayed. US2004128034 patent application disclose liquid flow detection using a microphone or other acoustic sensor to detect the acoustic signature of liquid flow through a pipe. Based on the analysis of the acoustic signature of the liquid flow, a determination is made whether a fault or leak in the line has occurred.

WO 0151904 patent application discloses a method for detection of leaks in plastic water distribution pipes by processing the sound or vibration induced in the pipe by water escaping under pressure. The leak is located using the difference in arrival times of two leak signals as determined from the cross-correlation function traditionally used in leak detection applications or an enhanced impulse response function.

EP 1077371 patent application disclose a method for detection of leaks using leak-specific sound signals, and/or the detection of the level in the fitting with an arrangement mounted in at least one fitting and/or pipeline, and outputting a leak alarm signal if a leak is detected and./or a level warning signal if the level exceeds or falls below a certain value.

The various leak detection methods described above use acoustic sensors located within the pipes, requiring complicated algorithm for identifying leak along the pipe, such solution may not be use to detect real time fluid leak within pipe construction for immediate activation of shutoff valve.

### BRIEF SUMMARY

The present invention provides a system for identifying leaks in liquids pipe construction. The system is comprised of: At least one detection unit is positioned in proximity of at least one exit point of said pipe construction comprising an acoustic sensor and a wireless communication unit, an electronically controlled shutoff unit installed on an entrance point of the pipe construction, the unit comprising a valve, an acoustic sensor and wireless communication unit arranged for transmitting data of water flow and receiving control signals, a controller network device for receiving the measurement data from all sensors. The controller is programmed to detect leaks when identifying differences between the measured liquid flow at the entrance point and measured flow at the exit points.

The controller according to some embodiments of the present invention is programmed to block said entrance point upon identifying leaks.

The controller may further include cellular network module and SIM card for transmitting the leak alerts to predefined phone numbers.

According some embodiments of the present invention the controller is programmed to detect leaks when identifying measured liquid flow at the entrance point and non measured flow at all the exit points.

According to some embodiments of the present invention the pipe construction includes more than one entrance points and the controller is programmed to detect leaks when identifying differences between sum of the measured liquid flow at the entrance points and measured flow at the exit points.

According to some embodiments of the present invention the detection unit further comprises a processing unit, a filtering unit, amplifier unit, timer unit and comparator unit which are arranged to analyze sounds signals near by an exit point based on designated sound recognition algorithm.

According to some embodiments of the present invention the sound recognition algorithm is programmed to identify sounds signals related to water flow including “dripping” sounds at predefined distance and filtering out background noise.

According to some embodiments of the present invention the detection unit has a unique identifier code enabling the control unit to identify irregular flow at specific controlled exit point enabling quantitative data analysis of liquid flow in the pipe construction.

According to some embodiments of the present invention the shutoff valve unit is comprised of at least: acoustic sensor, wireless communication unit, a processor and an electronic controlled valve.

According to some embodiments of the present invention is provided a method for identifying leaks in liquids pipe construction. The method comprises the steps of: Identifying sounds signals in proximity of at least one exit point of said pipe construction, identifying sounds signals in proximity of at least one entrance point of said pipe construction, analyzing said sound signals to identify liquid flow at the exit points or the entrance point, transmitting the measured sound which indicate of liquid flow to a control unit and detecting leaks when identifying differences between the measured liquid flow at the entrance point and measured flow at the exit points.

According to some embodiments of the present invention the method further comprising the step of blocking said entrance point upon identifying leaks.

According to some embodiments of the present invention the method further comprises the step of transmitting the leak alerts to predefined phone numbers.

According to some embodiments of the present invention leaks are identified when a liquid flow is detected at the entrance point and non measured flow is measured at all the exit points.

According to some embodiments of the present invention the pipe construction includes more than one entrance points and a leaks is detected when identifying differences between sum of the measured liquid flow at the entrance points and measured flow at the exit points.

According to some embodiments of the present invention wherein the analysis of sounds signals for identifying water flow from an exit point is based on designated sound recognition algorithm arranged to identify sounds signals related to water flow.

According to some embodiments of the present invention sound recognition algorithm includes identifying dripping sounds at predefined distance and filtering out background noise.

### BRIEF DESCRIPTION OF THE DRAWINGS

The present invention will be more readily understood from the detailed description of embodiments thereof made in conjunction with the accompanying drawings of which:

FIG. 1 is a block diagram illustrating the components of the leak detection system according to some embodiments of the invention;

FIG. 2 is a block diagram illustrating the controller device according to some embodiments of the invention;

FIG. 3 is a block diagram of the detection unit according to some embodiments of the invention;

FIG. 4 is an illustration the flow leak detection process according to some embodiments of the invention;

FIG. 5 is an illustration the flow leak detection process according to some embodiments of the invention;

FIG. 6 is a block diagram the shutoff unit according to some embodiments of the invention;

FIG. 7 is an illustration tap and associated detection unit according to some embodiments of the invention; and

FIG. 8 is an illustration shutoff unit according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

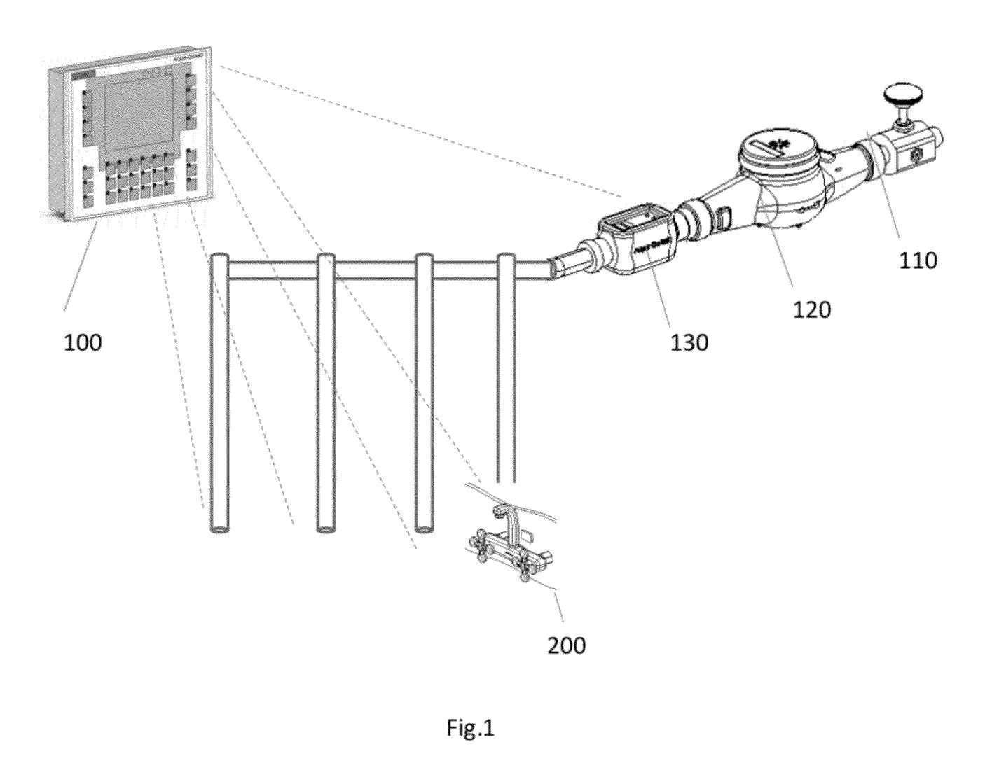

FIG. 1 illustrates the main components of the leak detection system implemented in pipe construction system according to the present invention. The system includes, a controller unit 100, entrances point valve 110, metering unit 112, shutoff unit 130 positioned at the entrance point and plurality of detection devices 140 positioned in proximity of controlled exit points of the pipe construction. The controller communicates through wireless communication link with the detection devices 140 and the shutoff unit 130 and is programmed to manage valves at the entrance point and the exits points on the basis of the received measurements from the acoustics sensors at the entrance point and exits points. The detection units 112 are position at different point, each unit in proximity to at least one controlled exit point such as a tap.

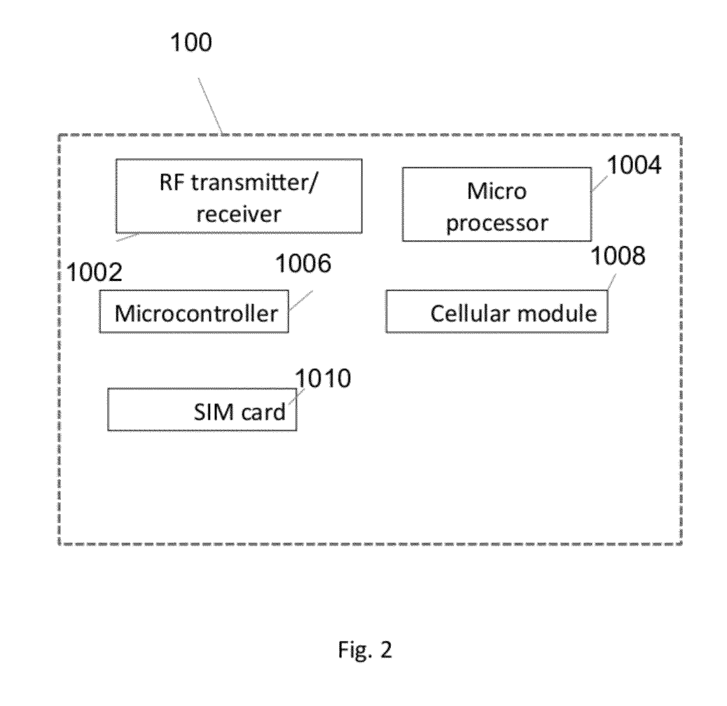

FIG. 2 is a block diagram illustrating of the controller device design according to some embodiments of the invention. The controller comprises a communication module 1002 such as an RF transmitter for communicating with the detection units, a micro processor which is programmed to analyze the measurements of received acoustic sensor and determine controls operation for each valve in the pipe construction according to an algorithm which is further described bellow. (Optionally the controller further comprise a micro controller). According to some embodiments of the present invention it is suggested to add cellular network module 1008(Such as GSM module) and a SIM card 1010 for enabling reporting alerts of identified leaks to predefined users phone numbers associated to technical support of the pipe construction.

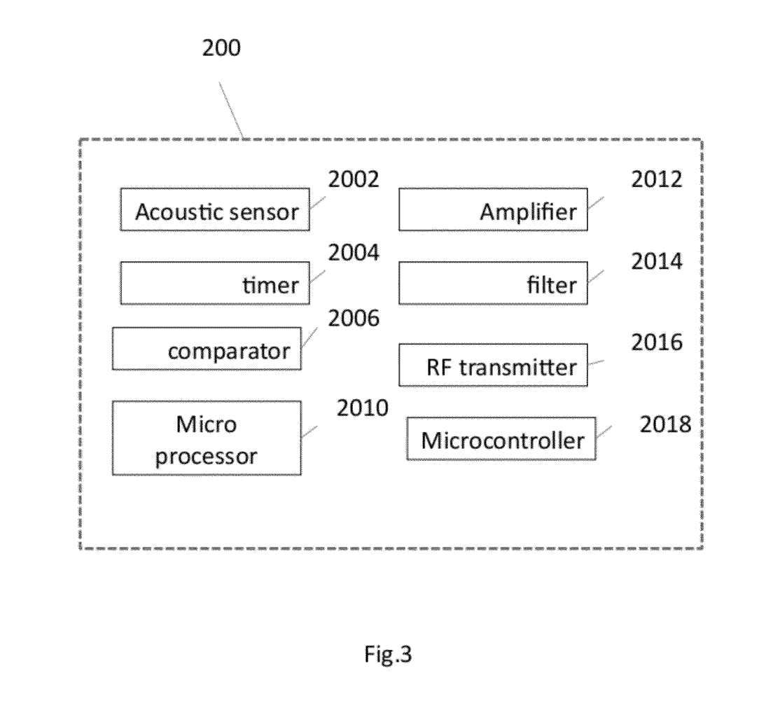

FIG. 3 is a block diagram of the detection unit design according to some embodiments of the invention. The detection unit comprises an acoustic sensor 2002 which measures sounds signals near by the detection unit for identifying water flow at a controllable exit point, such as a TAP, based on designated sound recognition algorithm. Such sound recognition algorithm programmed in the processing unit 2010, uses basic units including at least: a filtering unit 2014, amplifier unit 2012, timer unit 2004, comparator unit 2006 for identifying sound signals related to water flow including “dripping” sounds at predefined distance and filtering background noise. The analysis results may include only indication of detecting water flow beyond specific level. After analyzing the sounds signals, the micro processor operates a communication module such a an RF transmitter 2016 to convey the water flow measurement at the respective exit point. According to some embodiments of the detection unit can be implemented as a miniature electronic chip integrated as part of sticker (label) which can be easily attached on any object near by the respective exit point. According to some embodiments of the present invention, each detection unit has a unique identifier. Based on the measure flow data from identified detection units the controller device can report of irregularities in water flow at specific exits points.

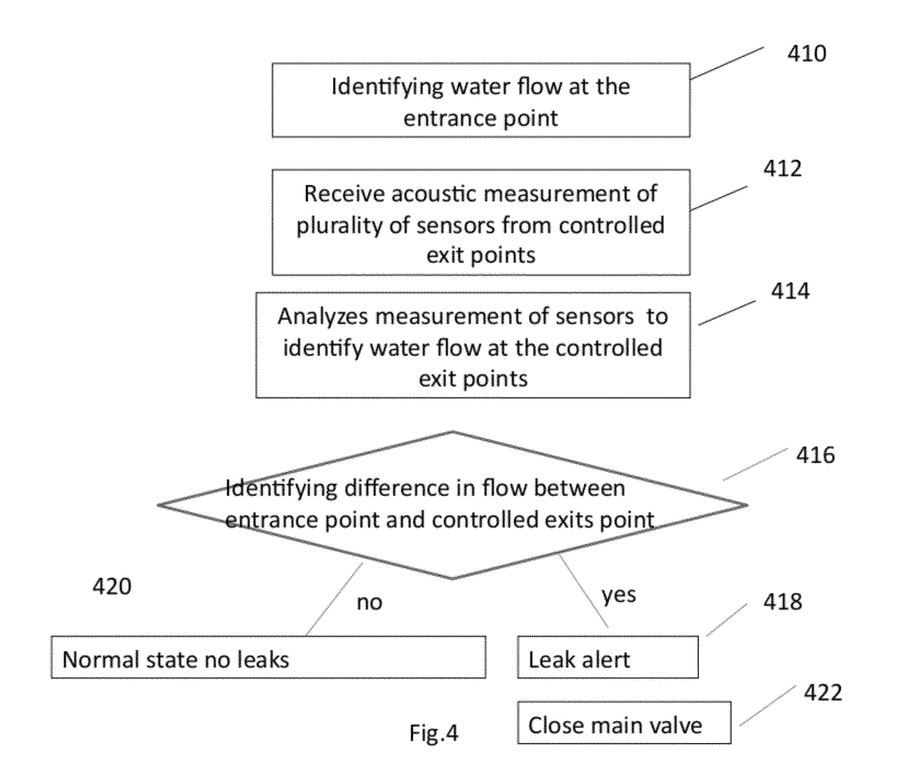

FIG. 4 is an illustration of the flow leak detection process according to some embodiments of the invention. The algorithm is activated by the controller, each time the measurement from the acoustic sensor at the entrance point indicates of water flow (step 410). Once a water flow is identified, the controller request and receives real-time measurements from acoustics sensors positioned in proximity to the controlled exit points(step 412). The measurements are analyzed to identify water flow and quantity of water flow in all exit points (step 414). At the next step, the measurements of the acoustic sensors at the entrance point are compared to the measurements of the acoustic sensors at exit points (step 416). Incase of detecting the flow water at the entrance point is larger than sum of water flow from all exit points the algorithm may determine a leak alert state (step 418), otherwise normal state is determined (step 420). Incase of leak alert the controller determines if to send control signal to the shutoff unit for closing the valve at the mains entrance and/or send an alert message to pre-defined designated phone numbers. According to some embodiments of the present invention the pipe construction may include plurality of entrance points connected to plurality of exits point. In such construction the algorithm is adapted to compare the sum of water flow measurements from all entrance points to sum of water flow measurements from all exit points to for determining leaks states.

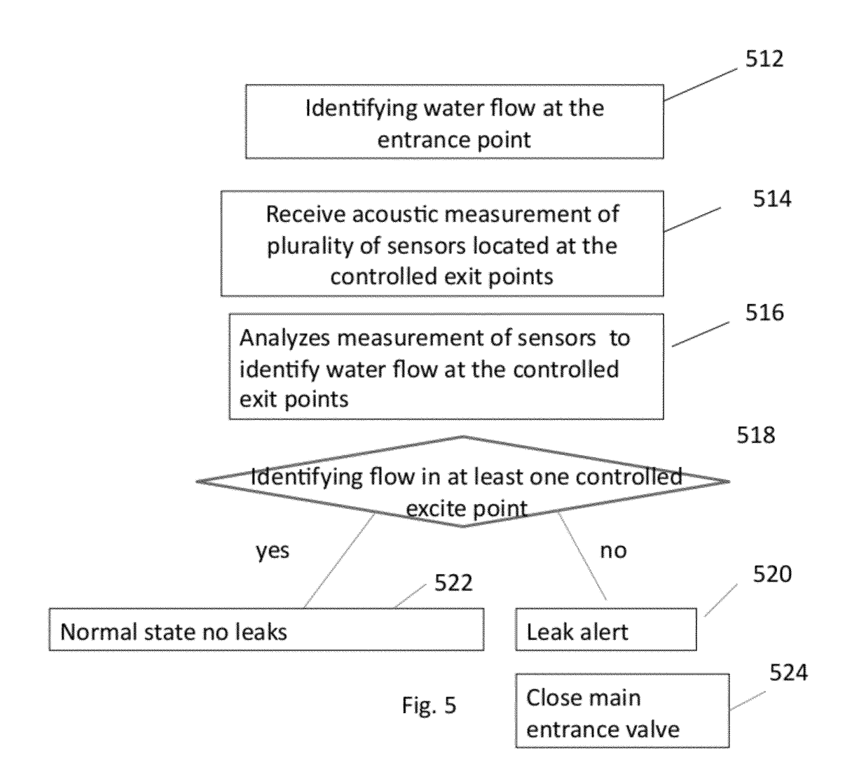

FIG. 5 is an illustration of the flow leak detection process according to some embodiments of the invention. This algorithm is equivalent to the algorithm described in FIG. 4, only assuming that all measured water flow from the entrance point is expected to be detected at the exit points. Under this assumption which is true for most private household pipe construction a leak is determined when a water flow is detected at the entrance point and no water flow is detected at the exit point (steps 518, 522 and 522).

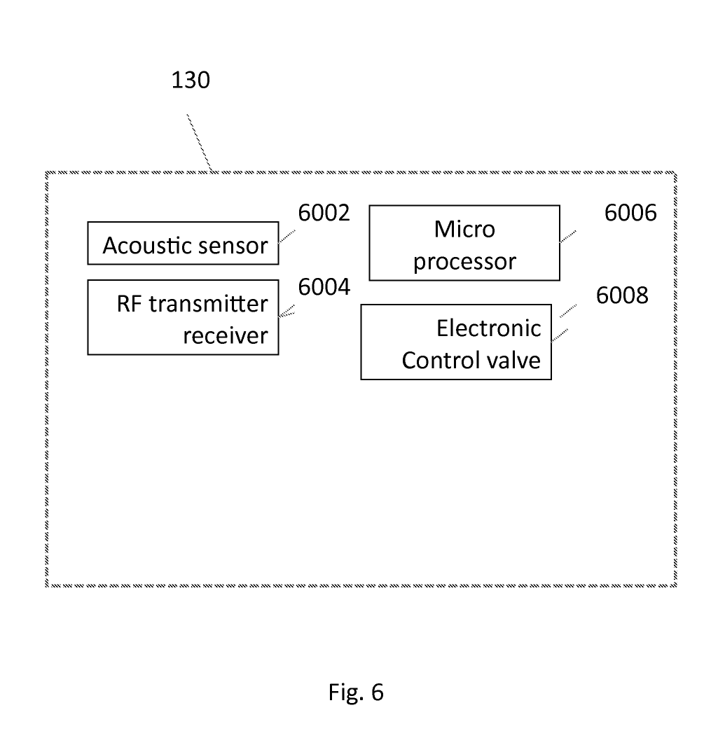

FIG. 6 is a block diagram the Shutoff unit design according to some embodiments of the invention. The detection unit comprises an acoustic sensor 6002 which measures sounds signals for identifying water flow at the entrance point based on designated sound recognition algorithm. Such sound recognition algorithm is programmed in the processing unit 6006. After analyzing the sounds signals, the micro processor operates a communication module such a an RF transmitter/receiver 6004 to convey measurement which indicate of water flow at the respective exit point. The electronic control valve 6008 is operated according to signal instruction coming from the controller through the receiver 6004. The electronic control valve activate the shutoff valve according to given instruction.

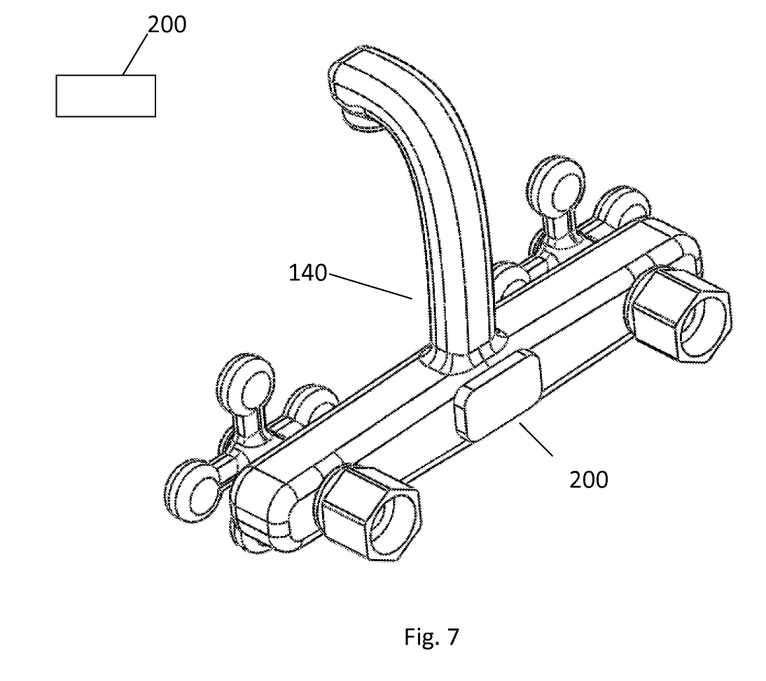

FIG. 7 is an illustration of a tap and associated detection unit according to some embodiments of the invention. The detection unit 200 is optionally attached at the rear side of a typical tap construction 140. Such position of the detection unit in proximity of the tap exit point enables to sense water flow coming out from the tap.

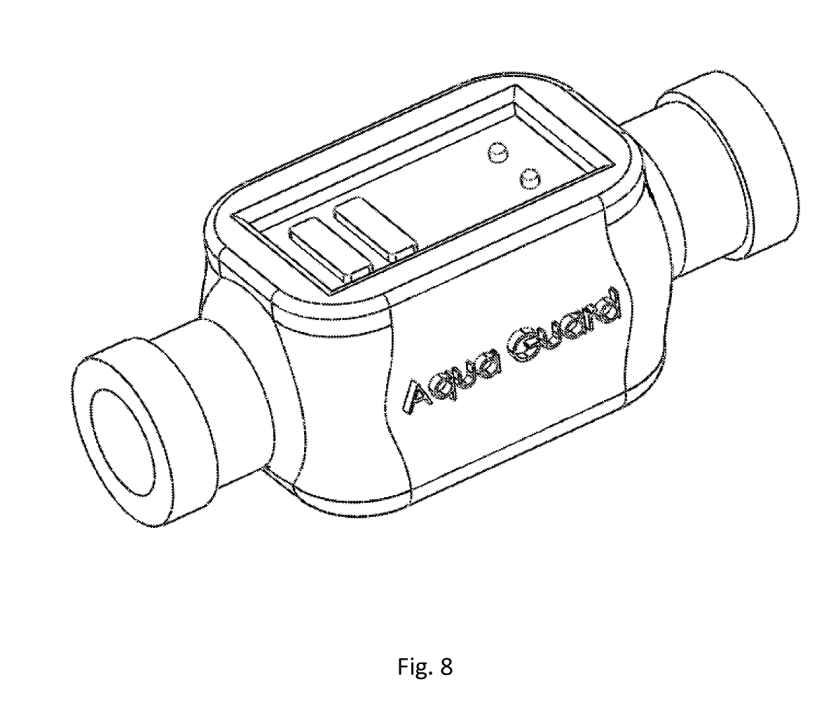

FIG. 8 is an illustration shutoff unit according to some embodiments of the invention. The shutoff unit includes connectors 8002 connected to the entrance point of the pipe construction, alarm led 8004, normal mode led 8006 and displays 8008.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An system for identifying leaks in liquids pipe construction, said system comprised of:
at least one detection unit comprising an acoustic sensor for measuring liquid flow and a wireless communication unit, said detection unit is positioned in proximity of at least one exit point of said pipe construction;
at least one electronically controlled shutoff unit comprising a valve, an acoustic sensor and wireless communication unit, said shutoff unit installed on an entrance point of the pipe construction, said communication unit arranged for transmitting data of water flow and receiving control signals;
at least one controller network device, for receiving the measurement data from all sensors, wherein said controller is programmed to detect leaks when identifying differences between the measured liquid flow at the entrance point and measured flow at the exit points.

2. The system of claim 1 wherein the controller is programmed to block said entrance point upon identifying leaks.

3. The system of claim 1 wherein the controller device further include cellular network module and SIM card for transmitting the leak alerts to predefined phone numbers.

4. The system of claims 1 wherein the controller is programmed to detect leaks when identifying measured liquid flow at the entrance point and non measured flow at all the exit points.

5. The system of claim 1 wherein the pipe construction includes more than one entrance points and the controller is programmed to detect leaks when identifying differences between sum of the measured liquid flow at the entrance points and measured flow at the exit points.

6. The system of claim one wherein the detection unit further comprises a processing unit, a filtering unit, amplifier unit, timer unit and comparator unit which are arranged to analyze sounds signals near by an exit point based on designated sound recognition algorithm.

7. The system of claim 6 wherein the sound recognition algorithm is programmed to identify sounds signals related to water flow including “dripping” sounds at predefined distance and filtering out background noise.

8. The system of claim 1 wherein the detection unit has a unique identifier code enabling the control unit to identify irregular flow at specific controlled exit point enabling quantitative data analysis of liquid flow in the pipe construction.

9. The system of claim 1 wherein the shutoff valve unit is comprised of at least:
acoustic sensor, wireless communication unit, a processor and an electronic controlled valve.

10. A method for identifying leaks in liquids pipe construction, said method comprise the steps of:
Identifying sounds signals in proximity of at least one exit point of said pipe construction;
Identifying sounds signals in proximity of at least one entrance point of said pipe construction;
Analyzing said sound signals to identify liquid flow at the exit points or the entrance point;
Transmitting the measured sound which indicate of liquid flow to a control unit;
detect leaks when identifying differences between the measured liquid flow at the entrance point and measured flow at the exit points.

11. The method of claim 10 further comprising the step of blocking said entrance point upon identifying leaks.

12. The method of claim 10 further comprising the step of transmitting the leak alerts to predefined phone numbers.

13. The method of claims 10 wherein leaks are identified when a liquid flow is detected at the entrance point and non measured flow is measured at all the exit points.

14. The method of claim 10 wherein the pipe construction includes more than one entrance points and a leaks is detected when identifying differences between sum of the measured liquid flow at the entrance points and measured flow at the exit points.

15. The method of claim 10 wherein the analysis of sounds signals for identifying water flow from an exit point is based on designated sound recognition algorithm arranged to identify sounds signals related to water flow.

16. The method of claim 15 wherein sound recognition algorithm includes identifying dripping sounds at predefined distance and filtering out background noise.
